(19) United States
(12) Patent Application Publication
(10) Pub. No.: US 2003/0107886 A1
(43) Pub. Date: Jun. 12, 2003

(54) Foldable lighting structure

(76) Inventor: Wen-Hua Pan, Taipei City (TW)

Correspondence Address: BACON & THOMAS, PLLC, 625 SLATERS LANE, FOURTH FLOOR, ALEXANDRIA, VA, 22314

(21) Appl. No.: 10/006,220

(22) Filed: Dec. 10, 2001

(51) Int. Cl. F21S 13/14; F 21Y 1 3/02

(52) U.S. Cl. 362/216; 362/225; 362/252; 362/124

(57) ABSTRACT

A foldable lighting structure comprises a decorative frame and a plurality of support members that assemble with one another via a mount of flanges and insertion rods arranged there between. Thereby, the support members can be easily separated from the decorative frame while the decorative frame can further be dismantled into separated parts. Hence constructed, the foldable lighting structure can be dismantled and folded to reduce its occupation space.

### FIELD OF THE INVENTION

The invention relates to a foldable lighting structure. More particularly, the invention provides a person-like or animal-like shaped lighting structure that can be easily assembled and dismantled.

### BACKGROUND OF THE INVENTION

To convey an atmosphere of joy during celebration moments, various types of decorative products seasonally appear in accordance with the arrival of expected celebration and festival periods. A representative example is the lighting decoration that is absolutely necessary during Christmas and New Year's celebrations, or specific anniversary days. Besides for specific celebration purposes, lighting products more generally compose an important part of our living environment.

Conventional “surface” lighting products offer the advantages of having reduced occupation space and easy disposition. Surface lighting products typically refer to conventional lamps arranged on wall or ceiling surfaces. Because surface lighting structures can not be held in standing position, they thus lack lifelike aspects.

“Spatial” lighting structures that can be placed in standing position are conventionally animal-like or person-like shaped with support members that enable the standing position. These lighting structures are conventionally comprised of an integrally fixed frame on which light tubes or light bulbs are mounted. After the celebration is over, this conventional lighting structure can be only partially dismantled while the frame cannot be dismounted. After-use disposition and transportation of the lighting structure is therefore usually cumbersome, and the lighting structure sometimes may be even thrown away.

Certain presently commercialized lighting products may be assembled with specific connection members that allow further dismantling to reduce the occupation space. However, specific tools are usually necessary to accomplish the assembly and dismantle operations, which may be not an ideal solution because it may be time-consuming and not easy to achieve.

### SUMMARY OF THE INVENTION

It is therefore a principal object of the invention to overcome the above deficiencies by providing a foldable lighting structure that can be easily assembled and dismantled without the need of specific tools.

In accordance with the above objectives, a foldable lighting structure of the invention includes a decorative frame and a plurality of support members that are assembled with one another by means of a plurality of flanges and insertion rods. The flanges and insertion rods assemble with one another via simple insertion operation so that the support members and the decorative frame can be easily assembled and dismantled with respect to one another, while the decorative frame can be further dismantled into various parts. The foldable lighting structure can be thereby easily disposed and transportable.

To provide a further understanding of the invention, the following detailed description illustrates embodiments and examples of the invention, this detailed description being provided only for illustration of the invention.

### BRIEF DESCRIPTION OF THE DRAWINGS

The drawings included herein provide a further understanding of the invention and, incorporated herein, constitute a part of the invention disclosure. A brief introduction of the drawings is as follows:

FIG. 1 is a perspective general view of a foldable lighting structure according to an embodiment of the invention;

FIG. 2A, FIG. 2B, and FIG. 2C are enlarged perspective views schematically showing various assembled parts of a foldable lighting structure according to an embodiment of the invention; and

FIG. 3 is a perspective view schematically showing a use of the invention.

### DESCRIPTION OF THE PREFERRED EMBODIMENTS

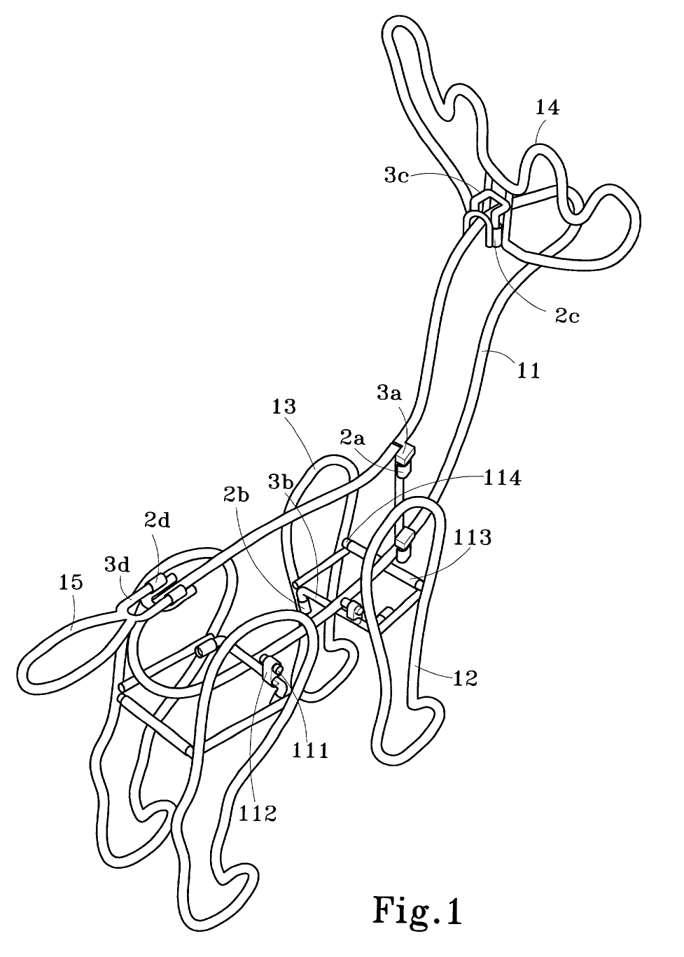

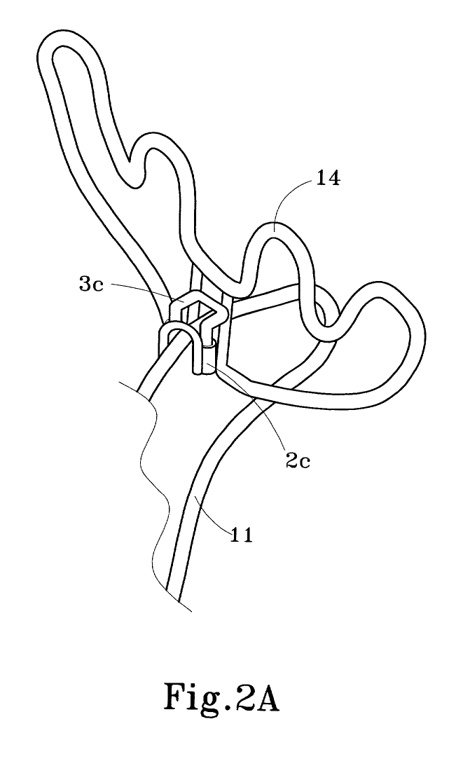

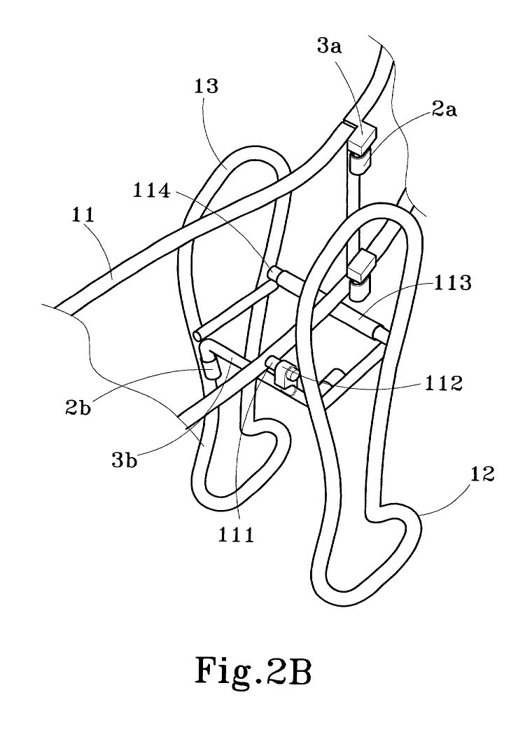

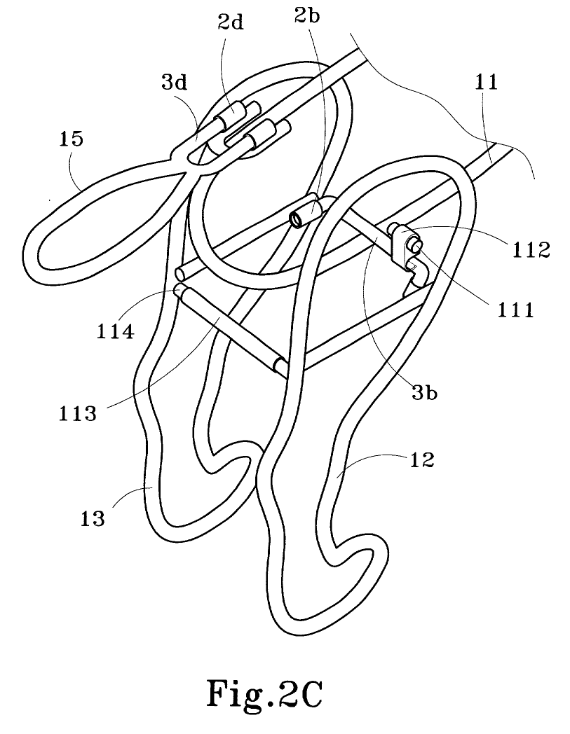

Referring to FIG. 1, FIG. 2A, FIG. 2B, and FIG. 2C, various perspective views schematically show various parts of a lighting foldable structure according to an embodiment of the invention. A lighting structure 1 comprises a decorative frame 11 at two sides thereof are disposed support members 12, 13, while light-emitting elements 17 is disposed on the decorative frame 11. To assemble the decorative frame 11 and the support members 12, 13, a plurality of flanges 2a, 2b and insertion rods 3a, 3b that assemble with one another by insertion are disposed on the decorative frame 11 and between the support members 12, 13.

As shown in FIG. 2C, an auxiliary bar 111 is mounted on the insertion rod 3b between the support members 12, 13 via a connecting sleeve 112 to assemble the support members 12, 13 with the decorative frame 11. Thereby, the support members 12, 13 can enable stable standing of the whole lighting structure; meanwhile, the support members 12, 13 and the decorative frame 11 can be further easily dismantled into multiple parts. The lighting structure 1 of the invention is thereby foldable.

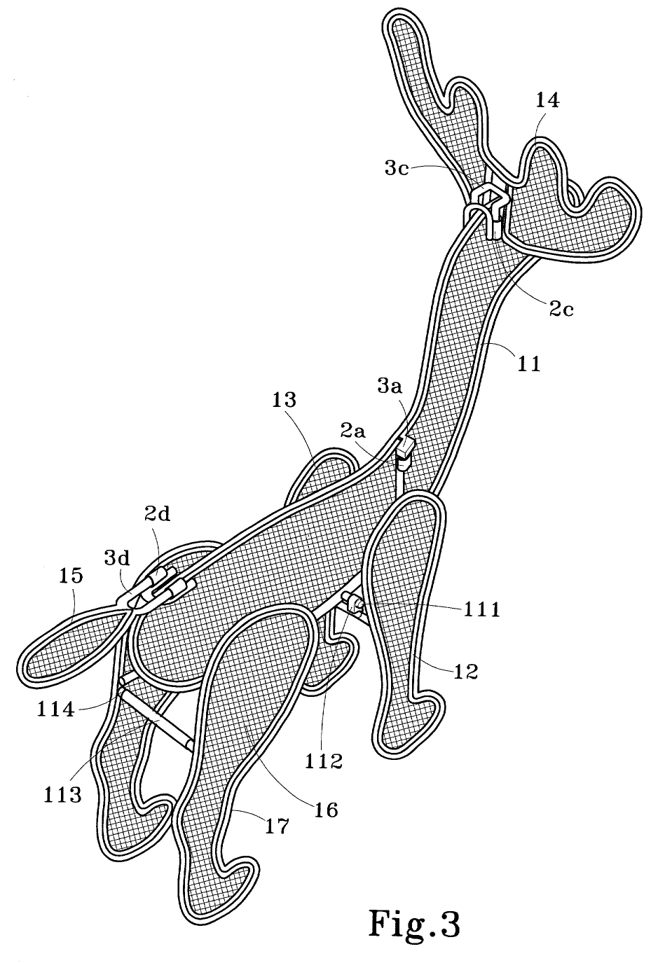

The lighting structure 1 can be variously shaped into animal-like shape or person-like shape, for example. The drawings illustrate the example of a deer-like shaped lighting structure 1 in which the decorative frame 11 composes the body and the support members 12, 13 constitute the members of the deer-like lighting structure 1. Auxiliary decorative parts 14, 15 representing the horn and the tail are further included to the body-like decorative frame 11 to provide more detailed representations of the deer-like lighting structure 1. Flanges 2c, 2d and insertion rods 3c, 3d enable to assemble the auxiliary decorative parts 14, 15 with the decorative frame 11. As shown in FIG. 3, the decorative frame 11, the support members 12, 13, and the auxiliary decorative parts 14, 15 are comprised of frames that are internally meshed with grids. The light-emitting element 17 typically can include a light bulb or light tube, and is made of flexible and foldable materials so that the light-emitting element 17 can be folded along with the lighting structure 1.

As shown in FIG. 2A and FIG. 2C, by using an assembly mechanism comprised of flanges 2c, 2d and insertion rods 3c, 3d, the user can easily separate the auxiliary decorative parts 14, 15 from the decorative frame 11. Similarly as shown in FIG. 2B, by using flange 2a and insertion rod 3a, the decorative frame 11 can be easily dismantled in two parts to reduce its occupation space.

As shown in FIG. 2B, after the insertion rod 3b is separated from the flange 2b fixed on the support members 12, 13, the support members 12, 13 can be further folded toward the decorative frame 11. In addition, connecting beams 114 may further extend from each of the support members 12, 13 to respectively insert in a connecting sleeve 113. Thereby, the support members 12, 13 can be better connected with each other and a more stable standing support of the decorative frame 11 can be favorably achieved. By means of the connecting sleeve 112 and the auxiliary bar 111 inserted in the connecting sleeve 112, the insertion rod 3b can slide and connect to the support members 12, 13 while the connecting sleeve 112 is attached at a central location of the insertion rod 3b. A stable attachment can be thereby achieved.

What is claimed is:

1. A foldable lighting structure comprising:
a decorative frame and a plurality of support members disposed at two sides of the decorative frame, wherein the decorative frame and the support members are provided with light-emitting elements thereon; and
a plurality of flanges and insertion rods mounted between the decorative frame and the support members and attached with one another by insertion, thereby the support members can be easily assembled and dismantled while the decorative frame can be dismantled into a plurality of parts.

2. The foldable lighting structure of claim 1, further being animal-like shaped.

3. The foldable lighting structure of claim 1, further being person-like shaped.

4. The foldable lighting structure of claim 1, wherein the decorative frame is person body-like shaped or animal body-like shaped.

5. The foldable lighting structure of claim 1, wherein the support members are animal members-like shaped or person members-like shaped.

6. The foldable lighting structure of claim 1, further including a plurality of auxiliary parts that are animal horn-like, ear-like, or tail-like shaped.

7. The foldable lighting structure of claim 6, wherein the decorative frame and the auxiliary parts are assembled with one another via a plurality of flanges and insertion rods.

8. The foldable lighting structure of claim 6, wherein the auxiliary parts are comprised of frames internally meshed with grids.

9. The foldable lighting structure of claim 1, wherein the decorative frame and the support members are comprised of frames internally meshed with grids.

10. The foldable lighting structure of claim 1, wherein the light-emitting element is a light bulb or a light tube.

11. The foldable lighting structure of claim 1, wherein a connecting sleeve is further mounted onto one insertion rod between the decorative frame and the support members while an auxiliary bar is inserted in the connecting sleeve to thereby connect the decorative frame and the support members and achieve effective standing support.
